(19) United States
(12) Patent Application Publication
(10) Pub. No.: US 2019/0259172 A1
(43) Pub. Date: Aug. 22, 2019

(54) DETECTING METHOD AND DETECTING DEVICE

(71) Applicant: SCREEN HOLDINGS CO., LTD., Kyoto (JP)

(72) Inventors: Hiroaki KAKUMA, Kyoto (JP); Kensuke SAKATA, Kyoto (JP)

(73) Assignee: SCREEN HOLDINGS CO., LTD., Kyoto (JP)

(21) Appl. No.: 16/333,511

(22) PCT Filed: Jun. 15, 2017
(86) PCT No.: PCT/JP2017/022172

§ 371 Date: Mar. 14, 2019

(30) Foreign Application Priority Data
Sep. 28, 2016 (JP) 2016-189893

(51) Int. Cl. G06T 7/70; G01V 8/10; B05C 11/00; B05C 5/00; B05D 1/00

(52) U.S. Cl. CPC G06T 7/70; G01V 8/10; B05D 1/005; B05C 5/002; B05C 11/00

(57) ABSTRACT

Provided is a technique for detecting whether or not there is a drop of a liquid in a non-supply period. There are performed the steps of: imaging in a non-supply period during which supply of liquid to a target nozzle among one or more nozzles is stopped while allowing an imaging visual field to include a dropping path through which the liquid drops from an opening of the target nozzle; and detecting whether or not there is a drop of the liquid using an imaging result in the imaging step. This enable detecting whether or not there is a drop of the liquid from the target nozzle in a non-supply period during which supply of the liquid toward the target nozzle is stopped.

### TECHNICAL FIELD

The present invention relates to a technique for detecting whether or not there is a drop of liquid from a nozzle at an unintended timing.

### BACKGROUND ART

There is known a technique for determining whether or not a liquid is properly supplied in a process of supplying a liquid to an object such as a substrate.

For example, the technique disclosed in Patent Document 1 is configured to compare an image obtained by imaging the periphery of an opening of a nozzle positioned above a substrate immediately before supply of liquid, with an image obtained by imaging the periphery of the opening of the nozzle positioned above the substrate during the supply of liquid. This technique enables determining whether or not a liquid is supplied from the nozzle toward the object as expected in a supply period during which the liquid is supplied toward the nozzle.

### PRIOR ART DOCUMENT

### Patent Document

Patent Document 1: Japanese Unexamined Patent Application Laid-Open No. 2015-173148

### SUMMARY

### Problem to be Solved by the Invention

Unfortunately, the above technique does not enable detecting whether or not there is a drop of liquid from the nozzle in a non-supply period during which the supply of liquid toward the nozzle is stopped. For example, when minute scratches occur in an on-off valve interposed in a flow path from a liquid supply source to a nozzle, a liquid in the flow path leaks downstream of the on-off valve, and then the liquid may drop as described above.

Dropping of liquid in the non-supply period (or dropping of liquid at unintended timing) causes a yield of an object to be lowered, so that there is room for improvement in detecting whether or not there is such a drop.

The present invention is made in light of the above-mentioned problem, and an object thereof is to provide a technique for detecting whether or not there is a drop of liquid in a non-supply period.

### Means to Solve the Problem

A detecting method according to a first aspect includes the steps of: imaging in a non-supply period during which supply of liquid to a target nozzle among one or more nozzles is stopped while allowing an imaging visual field to include a dropping path through which the liquid drops from an opening of the target nozzle; and detecting whether or not there is a drop of the liquid using an imaging result in the imaging step.

The detecting method according to a second aspect is the detecting method of the first aspect in which the imaging visual field is a region above an object to which the liquid is supplied, and in the imaging step, it is detected whether or not there is a drop of the liquid from the target nozzle positioned above the object.

The detecting method according to a third aspect is the detecting method according to the second aspect further includes the step of retracting the target nozzle from above the object immediately after the imaging step.

The detecting method according to the second aspect includes a detecting method according to a fourth aspect that further includes supplying the liquid toward the object from the target nozzle immediately after the imaging.

The detecting method according to a fifth aspect is the detecting method according to any one of first to fourth aspects in which the one or more nozzles include a nozzle group consisting of a plurality of nozzles that is integrally moved, and a nozzle that is moved alone, and in which the target nozzle includes at least the nozzle group.

A detecting device according to a sixth aspect of the present invention includes one or more nozzles, an imaging unit that, in a non-supply period during which supply of liquid toward a target nozzle among the one or more nozzles is stopped, images a dropping path through which the liquid drops from an opening of the target nozzle, and a detection unit that detects whether or not there is a drop of the liquid using an imaging result of the imaging unit.

### Effects of the Invention

The detecting methods according to the first to fifth aspects and the detecting device according to the sixth aspect enable detecting whether or not there is a drop of liquid from a target nozzle in a non-supply period during which supply of the liquid toward the target nozzle is stopped.

### BRIEF DESCRIPTION OF DRAWINGS

FIG. 1 is a plan view of an aspect of a substrate treatment system including a substrate treatment apparatus.

FIG. 2 is a plan view illustrating a structure of a substrate treatment apparatus 1A.

FIG. 3 is a sectional view of the substrate treatment apparatus 1A taken along line III-III in FIG. 2, and illustrates a configuration of a control unit.

FIG. 4 is a diagram illustrating a timing chart of a process example in the substrate treatment apparatus 1A.

FIG. 5 is a diagram illustrating functional blocks for executing a positioning process, a determination process, and a detection process, described later.

FIG. 6 illustrates an example of a reference image Iref imaged in a state where a nozzle 43a is positioned at an appropriate treatment position.

FIG. 7 illustrates an example of an image Im imaged when a treatment liquid is continuously discharged from the nozzle 43a positioned at the treatment position.

FIG. 8 is a diagram illustrating an example of image contents of a determination region.

FIG. 9 is a diagram illustrating an example of image contents of the determination region.

FIG. 10 is a diagram illustrating an example of image contents of the determination region.

FIG. 11 is a diagram illustrating data processing in the determination process.

FIG. 12 is a graph illustrating the data processing in the determination process.

FIG. 13 is a graph illustrating a relationship between an evaluation value and a threshold value.

FIG. 14 is a graph illustrating a relationship between an evaluation value and a threshold value.

FIG. 15 is a graph illustrating a relationship between an evaluation value and a threshold value.

FIG. 16 is a flowchart of the determination process.

FIG. 17 illustrates an example of an image In obtained by imaging a nozzle group 43 positioned at the treatment position.

FIG. 18 is a graph illustrating a relationship between a value of a standard deviation α as an evaluation value obtained for each frame, and time (frame number).

### DESCRIPTION OF EMBODIMENTS

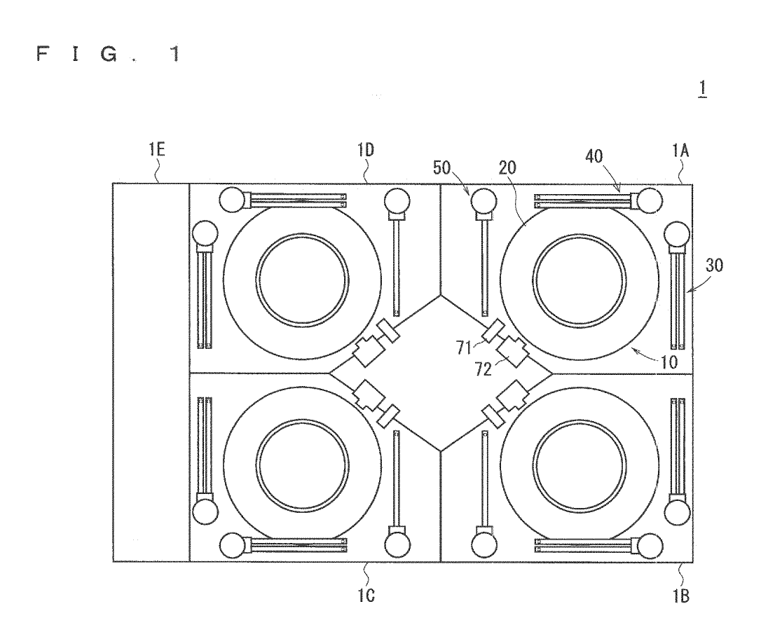

Hereinafter, embodiments will be described in detail with reference to the drawings. It should be noted that the dimensions of components and the number of components are shown in exaggeration or in simplified form, as appropriate, in FIG. 1 and the subsequent figures for the sake of easier understanding.

### 1. First Preferred Embodiment

### 1.1 General Configuration of Substrate Treatment System 1

FIG. 1 is a plan view of a substrate treatment system including a substrate treatment apparatus.

A substrate treatment system 1 includes substrate treatment apparatuses 1A to 1D each capable of performing a predetermined process on a substrate independently of each other, an indexer unit 1E provided with an indexer robot (not illustrated) for transferring a substrate between the substrate treatment apparatuses 1A to 1D and the outside, and a control unit 80 (refer to FIG. 3) for controlling operation of the entire system. The number of substrate treatment apparatuses may be arbitrarily set. Thus, four substrate treatment apparatuses disposed horizontally as described above constitute one stage, and a plurality of the stages may be stacked vertically.

Hereinafter, a substrate treatment system used for processing a semiconductor substrate, for example, will be described. In addition to the semiconductor substrate, a glass substrate for a photomask, a glass substrate for a liquid crystal display, a glass substrate for a plasma display, a substrate for a field emission display (FED), a substrate for an optical disk, a substrate for a magnetic disk, a substrate for a magneto-optical disk, and the like can be used.

While the substrate treatment apparatuses 1A to 1D are each different in layout of each of units according to a placement position in the substrate treatment system 1, components of each of the units and operation thereof are identical. Accordingly, a configuration and operation of the substrate treatment apparatuses 1A among them will be described below, and a detailed description of each of the other substrate treatment apparatus 1B to 1D will be eliminated.

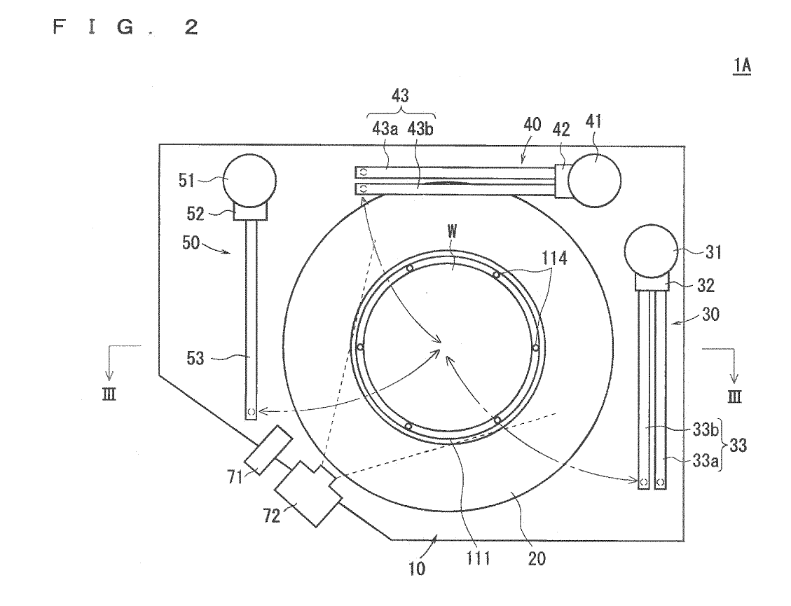

FIG. 2 is a plan view illustrating a structure of the substrate treatment apparatus 1A. FIG. 3 is a sectional view of the substrate treatment apparatus 1A taken along line III-III in FIG. 2, and illustrates a configuration of the control unit.

The substrate treatment apparatus 1A is a single-wafer type liquid treatment unit for applying liquid treatment such as cleaning treatment and etching treatment with a treatment liquid to a substrate W in a disk-shape such as a semiconductor wafer. The substrate treatment apparatus 1A includes a chamber 90 provided in its ceiling portion with a fan filter unit (FFU) 91. The fan filter unit 91 includes a fan 911 and a filter 912. This allows the external atmosphere taken in by operation of the fan 911 to be supplied to a treatment space SP in the chamber 90 through the filter 912. The substrate treatment system 1 is used while being installed in a clean room, and clean air is constantly fed into the treatment space SP.

The chamber 90 is provided in its treatment space SP with a substrate holder 10. The substrate holder 10 rotates a substrate W while holding the substrate W in a substantially horizontal posture by allowing a front surface of the substrate W to face upward. The substrate holder 10 includes a spin chuck 11 in which a spin base 111 in a disk-shape having an outer diameter slightly larger than that of the substrate W, and a rotation support shaft 112 extending substantially vertically, are integrally joined. The rotation support shaft 112 is connected to a rotation shaft of a chuck rotation mechanism 113 including a motor, and the spin chuck 11 is rotatable about a rotation axis (vertical axis) by being driven by a chuck driving unit 85 of the control unit 80. The rotation support shaft 112 and the chuck rotation mechanism 113 are accommodated in a casing 12 in a cylindrical shape. The rotation support shaft 112 is integrally connected at its upper end to a spin base 111 with a fastening component such as a screw, and the spin base 111 is supported by the rotation support shaft 112 in a substantially horizontal posture. Thus, when the chuck rotation mechanism 113 is operated, the spin base 111 rotates about the vertical axis. The control unit 80 can control the chuck rotating mechanism 113 using the chuck driving unit 85 to adjust a rotation speed of the spin base 111.

The spin base 111 is provided around its peripheral portion with a plurality of chuck pins 114 erected for holding a peripheral end portion of the substrate W. Three or more chuck pins 114 may be provided (six pins in this example) to securely hold a substrate W in a circular shape, and are disposed at equal angular intervals along the peripheral portion of the spin base 111. Each of the chuck pins 114 is configured to be switchable between a pressed state where the chuck pins 114 press an outer peripheral end face of the substrate W inward and a released state where the chuck pins 114 are separated from the outer peripheral end face of the substrate W.

While each of the plurality of chuck pins 114 is brought into the released state when a substrate W is transferred to and from the spin base 111, each of the plurality of chuck pins 114 is brought into the pressed state when a predetermined process is performed by rotating the substrate W. When the chuck pins 114 is brought into the pressed state as described above, the chuck pins 114 hold the peripheral end portion of the substrate W to enable the substrate W to be held in a substantially horizontal posture at a predetermined interval from the spin base 111. As a result, the substrate W is supported while its front surface faces upward and its back surface faces downward. As the chuck pin 114, a publicly known structure is available. As a mechanism for holding the substrate, it is not limited to the chuck pins, but a vacuum chuck for sucking the back surface of the substrate to hold the substrate W may be used.

Around the casing 12, a splash guard 20 is provided so as to surround the periphery of the substrate W held in a horizontal posture on the spin chuck 11 while being movable up and down along the rotation axis of the spin chuck 11. The splash guard 20 has a substantially rotationally symmetrical shape with respect to the rotation axis, and includes a multistage guard 21 (two-stage in this example) disposed concentrically with the spin chuck 11 to receive the treatment liquid scattered from the substrate W, and a liquid receiving part 22 for receiving the treatment liquid dropping from the guard 21. When the guard 21 is moved up and down in a stepwise manner by a guard lifting mechanism (not illustrated) provided in the control unit 80, a treatment liquid, such as a chemical solution or a rinse liquid, scattered from the substrate W rotating can be separately collected.

Around the splash guard 20, there is provided at least one liquid supply unit for supplying various kinds of treatment liquid, such as a chemical liquid such as an etching liquid, a rinse liquid, a solvent, pure water, deionized water (DIW), and the like to the substrate W. In this example, three treatment liquid discharge units 30, 40, and 50 are provided, as illustrated in FIG. 2.

The treatment liquid discharge unit 30 includes a rotation shaft 31 configured to be rotatable around a vertical axis by being driven by an arm driving unit 83 of the control unit 80, an arm 32 extending horizontally from the rotation axis 31, and two nozzles 33a and 33b each extending horizontally from the arm 32 and each having a downward opening. When the rotation shaft 31 is rotationally driven by the arm driving unit 83, the arm 32 swings around the vertical axis to move the nozzles 33a and 33b together along an arcuate trajectory indicated by a two-dot chain line in FIG. 2. More specifically, the nozzles 33a and 33b are moved back and forth together between a retracting position (a position indicated by a solid line in FIG. 3) outside the splash guard 20 and a position above the rotation center of the substrate W (a position indicated by a dotted line in FIG. 3). When a treatment liquid supply unit 84 feeds a treatment liquid to the nozzles 33a and 33b positioned above the substrate W, the treatment liquid is supplied to an upper surface of the substrate W. The treatment liquid to be fed to each of the nozzles 33a and 33b is preliminarily determined according to a recipe for treatment. For example, hydrofluoric acid is fed to the nozzle 33a as a treatment liquid, and pure water is fed to the nozzle 33b as a treatment liquid. The nozzles 33a and 33b are collectively referred to as a nozzle group 33 in the following description.

The treatment liquid discharge unit 40 includes a rotation shaft 41 rotationally driven by the arm driving unit 83, an arm 42 connected to the rotation shaft 41, two nozzles 43a and 43b extending horizontally from the arm 42 and each having a downward opening. When the rotation shaft 41 is rotationally driven by the arm driving unit 83, the arm 42 swings around the vertical axis to move the nozzles 43a and 43b together along an arcuate trajectory indicated by a two-dot chain line in FIG. 2. More specifically, the nozzles 43a and 43b are moved back and forth together between a retracting position outside the splash guard 20 and a position above the rotation center of the substrate W. When the treatment liquid supply unit 84 feeds a treatment liquid to the nozzles 43a and 43b positioned above the substrate W, the treatment liquid is supplied to an upper surface of the substrate W. The treatment liquid to be fed to each of the nozzles 43a and 43b is preliminarily determined according to a recipe for treatment. For example, an SC1 liquid (mixed liquid) is fed to the nozzle 43a as a treatment liquid, and pure water is fed to the nozzle 43b as a treatment liquid. The nozzles 43a and 43b are collectively referred to as a nozzle group 43 in the following description.

The treatment liquid discharge unit 50 includes a rotation shaft 51 rotationally driven by the arm driving unit 83, an arm 52 connected to the rotation shaft 51, a nozzle 53 extending horizontally from the arm 52 and having a downward opening. When the rotation shaft 51 is rotationally driven by the arm driving unit 83, the arm 52 swings around the vertical axis to move the nozzle 53 along an arcuate trajectory indicated by a two-dot chain line in FIG. 2. More specifically, the nozzle 53 is moved back and forth between a retracting position outside the splash guard 20 and a position above the rotation center of the substrate W. When the treatment liquid supply unit 84 feeds a treatment liquid to the nozzle 53 positioned above the substrate W, the treatment liquid is supplied to an upper surface of the substrate W. The treatment liquid to be fed to of the nozzle 53 is preliminarily determined according to a recipe for treatment. For example, an isopropyl alcohol (IPA) liquid is fed to the nozzle 53 as a treatment liquid.

While the substrate W is rotated at a predetermined rotational speed by rotation of the spin chuck 11, the treatment liquid discharge units 30, 40, and 50 position the corresponding nozzles 33a, 33b, 43a, 43b, and 53 above the substrate W in a predetermined sequential order to supply corresponding treatment liquids to the substrate W, thereby applying liquid treatment to the substrate W. Each of the treatment liquids supplied to the vicinity of the rotation center of the substrate W spreads outward due to a centrifugal force with rotation of the substrate W and is finally shaken off from a peripheral portion of the substrate W laterally. Each of the treatment liquids scattered from the substrate W is received by the guard 21 of the splash guard 20 and collected by the liquid receiving part 22.

The substrate treatment apparatus 1A further includes an illumination unit 71 for illuminating the inside of the treatment space SP and a camera 72 (imaging unit) for imaging the inside of the chamber, being provided adjacent to each other. While the illumination unit 71 and the camera 72 are disposed adjacent to each other horizontally in the illustrated example, the illumination unit 71 may be provided adjacent to the camera 72 vertically, that is, the illumination unit 71 may be provided just above or below the camera 72. The illumination unit 71 includes an LED lamp as a light source, for example, and supplies illumination light necessary for enabling imaging with the camera 72 into the treatment space SP. The camera 72 is provided at a position vertically higher than the substrate W, and has an imaging direction (or an optical axis direction of an imaging optical system) that is set obliquely downward toward substantially the rotation center of the substrate W to image the upper surface of the substrate W. This allows the camera 72 to have a visual field including the entire front surface of the substrate W held by the spin chuck 11. The visual field of the camera 72 horizontally includes a range surrounded by the broken lines in FIG. 2.

The imaging direction of the camera 72 substantially coincides with a direction of the light center of illumination light emitted from the illumination unit 71. Thus, when the illumination unit 71 illuminates a nozzle positioned at an upper position and a treatment liquid discharged from the nozzle, the camera 72 images a portion irradiated with direct light from the illumination unit 71. This enables an image with high brightness to be obtained. At this time, the illuminating unit 71 and the camera 72 are each provided at a position slightly above the nozzle, and thus avoid halation caused by incidence of regularly reflected light from the treatment liquid into the camera 72. The halation does not cause a problem in an object of simply detecting whether or not there is a drop of the treatment liquid, so that it may be configured such that regularly reflected light from the treatment liquid is incident into the camera 72. The illumination unit 71 may be disposed at any position as long as there is available a contrast allowing the treatment liquid to be distinguishable from background.

The illumination unit 71 and the camera 72 may be provided in the chamber 90, or may be configured to be provided outside the chamber 90 to illuminate or image the substrate W through a transparent window provided in the chamber 90. From a viewpoint of preventing the treatment liquid from adhering to the illumination unit 71 and the camera 72, it is desirable to provide them outside the chamber 90.

The camera 72 acquires image data that is given to an image processing unit 86 of the control unit 80. The image processing unit 86 performs image processing such as correction processing and pattern matching processing, described below, to the image data. As described below, the present embodiment allows positioning of each of the nozzles 33a, 33b, 43a, 43b, and 53, and detection of a drop of the treatment liquid from each of the nozzles 33a, 33b, 43a, 43b, and 53, to be performed on the basis of images taken by the camera 72.

The control unit 80 of the substrate treatment system 1 includes a CPU 81 for executing a predetermined processing program to control operation of each unit, a memory 82 for storing the processing program to be executed by the CPU 81 and data and the like created during processing, and an user interface (UI) unit 87 having an input function for accepting an operation input by a user, and an output function for notifying the user of progress of the processing, an occurrence of an abnormality, and the like, as necessary. When the processing program is executed by the CPU 81, a function of each of the functional units (the arm driving unit 83, the treatment liquid supply unit 84, the chuck driving unit 85, the image processing unit 86, etc.) of the control unit 80 is implemented. The control unit 80 may be individually provided in each of the substrate treatment apparatuses 1A to 1D, or only one set of the control unit 80 may be provided in the substrate treatment system 1 so as to comprehensively control each of the substrate treatment apparatuses 1A to 1D.

### 1.2 Processing Example

Hereinafter, examples of a positioning process, liquid treatment, a determination process, and a detection process, among processes to be performed in the substrate treatment apparatus 1A, will be described.

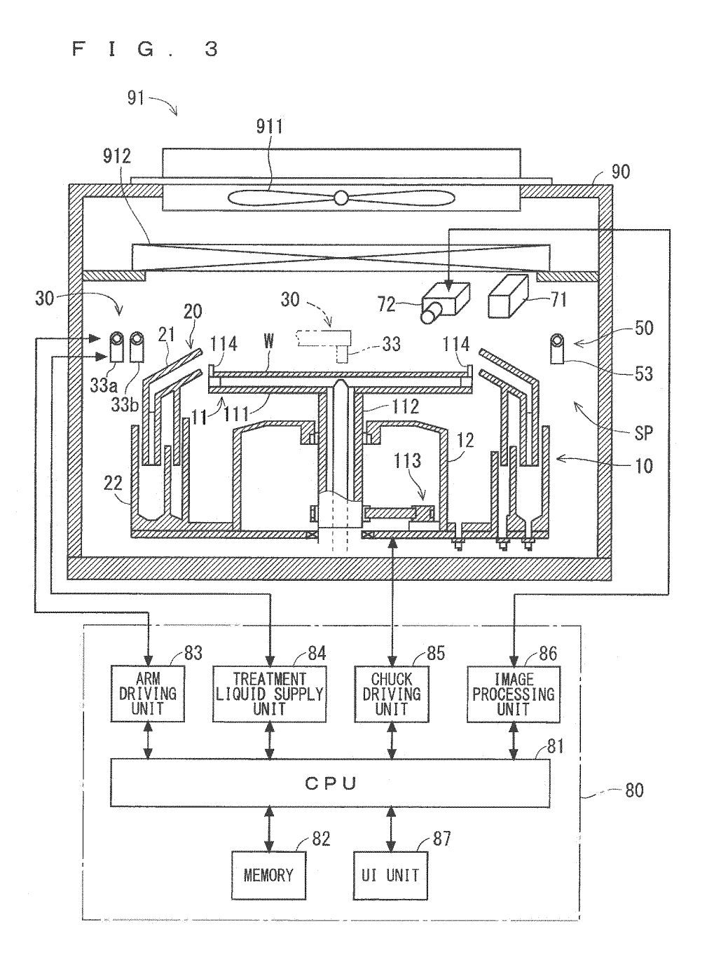

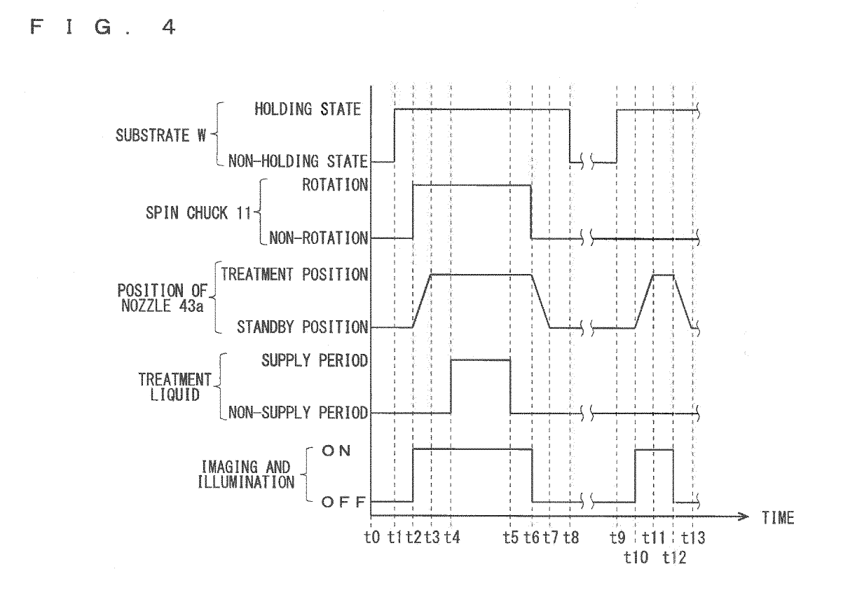

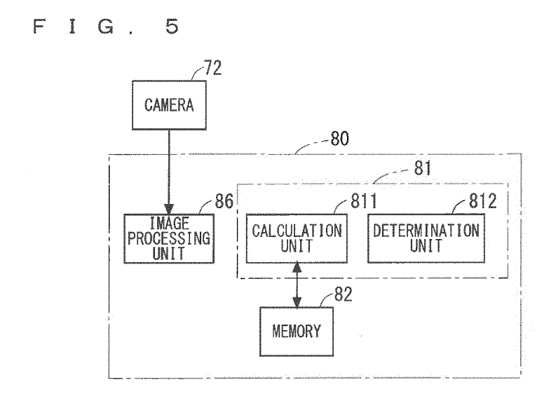

FIG. 4 is a diagram illustrating a timing chart of a process example in the substrate treatment apparatus 1A. FIG. 5 is a diagram illustrating functional blocks for executing the positioning process, the determination process, and the detection process, described later. FIG. 6 illustrates an example of a reference image Iref imaged in a state where the nozzle 43a is positioned at an appropriate treatment position. FIG. 7 illustrates an example of an image Im imaged when a treatment liquid is continuously discharged from the nozzle 43a positioned at the treatment position.

Each process in the substrate treatment apparatus 1A will be described below with reference to the respective drawings. Each of the processes below is implemented by the CPU 81 executing a predetermined processing program. While the processes each using the nozzle 43a will be described below, operation is similar to that of the nozzle 43a even when the other nozzles 33a, 33b, 43b, and 53 are used. A plurality of nozzles may be simultaneously used for treatment.

<1.2.1 Overall Flow>

When a substrate W is carried into the substrate treatment apparatus 1A, the substrate W is placed on the spin chuck 11, more specifically on the plurality of chuck pins 114 provided on the peripheral portion of the spin base 111. When the substrate W is carried into, the chuck pins 114 provided on the spin base 111 are in the released state. After the substrate W is placed, the chuck pins 114 are switched to the pressed state to hold the substrate W (time t1). This holding state continues during a period from time t1 to time t8.

After that, during the period from time t2 to time t3, the arm driving unit 83 moves the nozzle 43a from the retracting position to a proper treatment position (e.g., a position where the center of the opening of the nozzle 43a comes directly above the rotation center of the substrate W).

Liquid treatment requires a nozzle to be properly positioned at a treatment position to stably obtain good treatment results. The substrate treatment apparatus 1A determines a positional deviation of each of the nozzles in the vicinity of the treatment position on the basis of images taken by the camera 72 (time t2 to time t4).

During a period (a period from time t2 to time t3) for moving each of a nozzle and a period from movement of the nozzle to a start of discharge of the treatment liquid (a period from time t3 to time t4), positioning control of the nozzle 43a is performed while the position of the nozzle 43a in the reference image Iref is set as a target position. Specifically, imaging is performed by the camera 72 while the nozzle 43a is being moved, and a region substantially matching a reference pattern RP is retrieved for each image by pattern matching processing to detect the position of the nozzle 43a. The reference pattern RP is prepared prior to substrate treatment, and is acquired by cutting out a partial region corresponding to the image of the nozzle 43a from the reference image Iref. The reference pattern RP is cut out by an operator who specifies a rectangular area including the image of the nozzle 43a in the reference image Iref with the UI unit 87, for example.

The camera 72 takes images of the moving nozzle 43a with a plurality of frames. When the nozzle 43a is moving, contents of an image to be taken vary for each frame. Meanwhile, when the nozzle 43a is stopped, an image variation between consecutive frames also disappears. For example, a calculation unit 811 calculates a difference between images in respective frames taken at times adjacent to each other. Then, a determination unit 812 determines whether or not the nozzle 43a is stopped, depending on whether the difference is equal to or less than a predetermined value. The difference is calculated by integrating an absolute value of a difference between brightness values of pixels each corresponding to the same position in the two images, for all pixels, for example. To avoid erroneous determination due to noise or the like, images of three consecutive frames or more may be used for determination.

When it is determined that the nozzle 43a is stopped, one image taken at a time when the nozzle 43a seems to be stopped is specified from among a plurality of images taken continuously. Specifically, when it is determined that the nozzle 43a is stopped due to a difference between images of consecutive two frames, being equal to or less than a predetermined value, a previously taken image among those images may be set as the image at the time of stop, for example.

Based on the image at the time of stop, nozzle position anomaly determination is performed. The nozzle position anomaly determination is a process of determining whether or not the nozzle 43a is correctly positioned at a predetermined treatment position. When the image at the time of stop is compared with an image prepared prior to treatment for the substrate W (specifically, the reference image Iref imaged in a state where the nozzle 43a is positioned at the appropriate treatment position), it is determined whether or not a position of the nozzle is appropriate. When the amount of deviation between the position of the nozzle 43a at this time and the position of the nozzle 43a in the reference image Iref is equal to or smaller than a predetermined threshold value, it is determined that the position of the nozzle 43a is appropriate. Meanwhile, when the amount of deviation exceeds the threshold value, it is determined that the nozzle position is incorrect, and then the UI unit 87 notifies an operator that the nozzle position is incorrect.

The spin chuck 11 is rotated at a predetermined rotation speed (time t2 to time t6) after holding the substrate W, while the nozzle 43a is simultaneously positioned (time t2 to time t4). After the nozzle is positioned, liquid treatment is performed to the substrate W (time t4 to time t5). This period is a supply period for actively supplying liquid toward the nozzle by operating a pump or the like (not illustrated), and a treatment liquid is discharged from the nozzle 43a positioned at the treatment position. The treatment liquid flows down toward an upper surface of the substrate W rotating at a predetermined speed to be deposited near the center of rotation of the upper surface. Then the treatment liquid spreads on the substrate W radially outward due to a centrifugal force to cover the upper surface of the substrate W. As a result, the entire upper surface of the substrate W is treated with the treatment liquid.

When the treatment liquid is supplied for a predetermined time and the liquid treatment is completed, the rotation of the spin chuck 11 is stopped (time t6). Then, the nozzle 43a stopping discharge of the treatment liquid is moved to the retracting position (time t6 to time t7). After that, the chuck pins 114 provided on the spin base 111 are brought into the released state, and then a transfer robot (not illustrated) carries out the substrate W subjected to the liquid treatment from the substrate treatment apparatus 1A (time t8). As a process example different from the present embodiment, liquid treatment using another nozzle may be continuously performed by allowing the substrate W to be continuously rotated even after the liquid treatment by the nozzle 43a is completed.

<1.2.2 Determination Process and Detection Process>

In the present embodiment, there is performed a determination process for determining whether or not the treatment liquid is supplied to the substrate W at an appropriate timing, in the supply period (time t4 to time t5). In addition, in the present embodiment, there is performed a detection process for detecting whether or not there is a drop (referred to as dropping off) of liquid at an unintended timing, in a non-supply period in which liquid is not actively supplied toward a nozzle (time t3 to time t4, time t5 to time t6, and time t11 to time t12).

The determination process and the detection process are common in that a timing of a drop of the treatment liquid from the nozzle 43a is grasped using imaging results with the camera 72.

Meanwhile, the determination process and the detection process are different in a processing timing and an object of processing. Specifically, the determination process is performed in the supply period to determine whether or not the treatment liquid is appropriately supplied. In contrast, the detection process is performed in the non-supply period to detect whether or not there is a drop of the liquid at an unintended timing. In the present specification, a drop of liquid is a concept including both a flowing down of liquid in a continuous flow and a droplet dropping in a finely divided state.

Hereinafter, first, the determination process will be described in detail, and then the detection process will be described. The detection process will be described while similar portions to those of the determination process are appropriately eliminated.

Prior to the determination process, a partial region of the image Im including a dropping path where treatment liquid Lq discharged from the opening of the nozzle 43a drops toward the upper surface of the substrate W is set as a determination region Rj. While details will be described below, the determination process is configured to determine whether or not the treatment liquid Lq is being discharged from the nozzle 43a on the basis of an evaluation value calculated from a brightness value of each pixel constituting the determination region Rj. In addition, a threshold value for this determination is preliminarily set by an operator as a determination threshold value.

The determination process is a process of determining whether or not the treatment liquid Lq flows down from the opening of the nozzle 43a toward the upper surface of the substrate W. As will be described below, an algorithm of the determination process is configured to determine whether or not a drop of the treatment liquid Lq is recognized in the determination region Rj in images taken for one frame. Using this determination result also enables a discharge timing and a discharge time to be measured.

Specifically, each of images of a plurality of consecutively imaged frames is determined to enable specifying a discharge timing of the treatment liquid Lq from the nozzle 43a, or a time at which discharge is started and a time at which the discharge is stopped. This enables calculating the discharge time during which the discharge is continued.

The determination needs to be started at the latest before the discharge is started. This enables the determination to be started when the CPU 81 instructs the treatment liquid supply unit 84 to start discharge of the treatment liquid, for example. There is a slight time delay from when the instruction to start discharge is given until the treatment liquid Lq is actually discharged from the nozzle 43a. To detect a timing of ending the discharge, it is necessary to continue the determination for a while after the CPU 81 instructs the treatment liquid supply unit 84 to end the discharge of the treatment liquid.

Next, process contents of the determination will be described. As described above, the determination process in the present embodiment is a process of determining whether or not there is a drop of the treatment liquid Lq from the nozzle 43a on the basis of an image (still image) for one frame.

FIGS. 8 to 10 are each a diagram illustrating an example of image contents of the determination region. Hereinafter, an X direction and a Y direction are defined as follows. In a two-dimensional image expressed by matrix arrangement of a large number of minute pixels in two orthogonal directions, one arrangement direction is set as the X direction, and the other arrangement direction is set as the Y direction. When an upper left corner of an image is set as an original point, a lateral direction from the original point is the X direction and a longitudinal direction therefrom is the Y direction. As will be described below, it is preferable that any one of the X direction or the Y direction align with the vertical direction of an actual imaging object. In the present embodiment, the camera 72 is installed such that the Y direction coincides with the vertical direction.

As can be seen from a comparison between the reference image Iref in FIG. 6 and the image Im in FIG. 7, when the treatment liquid is not being discharged from the nozzle 43a, the upper surface of the substrate W behind the dropping path is visible at the position just below the nozzle 43a. Thus, an image appearing within the determination region Rj at an arbitrary imaging timing is one of the treatment liquid Lq and the upper surface of the substrate W. In other words, it is desirable that a placement position of the camera 72 be set so as to allow the camera 72 to have an imaging visual field as described above.

Only the upper surface of the substrate W appears in the determination region Rj without a drop of the treatment liquid, and there is no remarkable brightness change within the region as illustrated in the left diagram of FIG. 8. The right diagram of FIG. 8 shows an example of brightness distribution on a straight line L traversing the determination region Rj in the X direction. While there are variations in brightness due to irregular reflection by a pattern formed on the substrate W and reflection of internal parts of the chamber 90 as shown in the diagram, a relatively uniform brightness distribution is obtained.

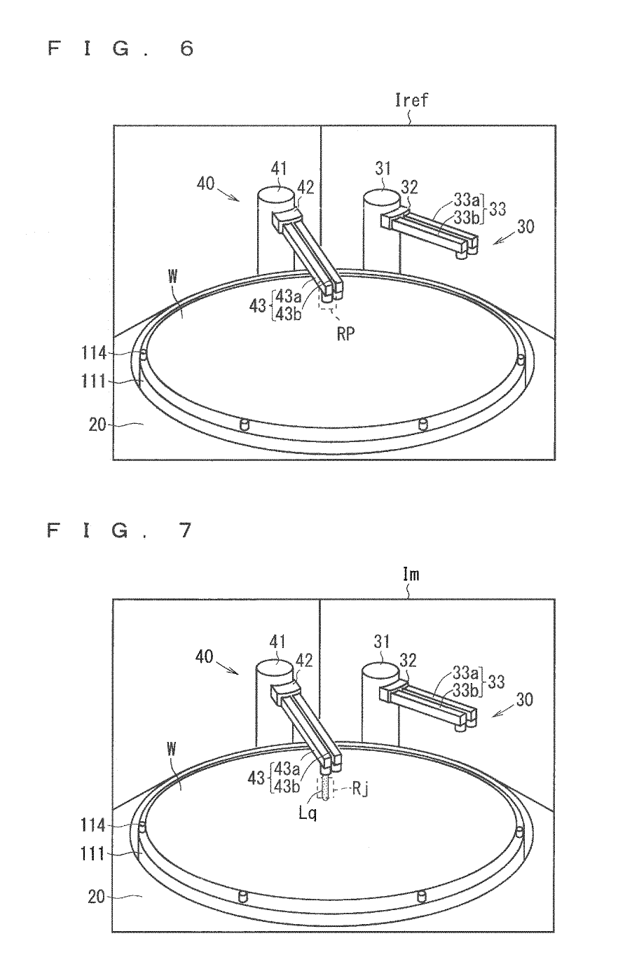

Meanwhile, when the treatment liquid Lq is continuously discharged from the nozzle 43a, an image of the treatment liquid Lq dropping in a columnar shape appears in the determination region Rj as shown in the left diagram of FIG. 9. When illumination light is incident from the same direction as the imaging direction of the camera 72, a surface of the liquid column made of the treatment liquid Lq appears bright and glows. That is, a portion corresponding to the liquid column has higher brightness than surroundings as shown in the right diagram of FIG. 9.

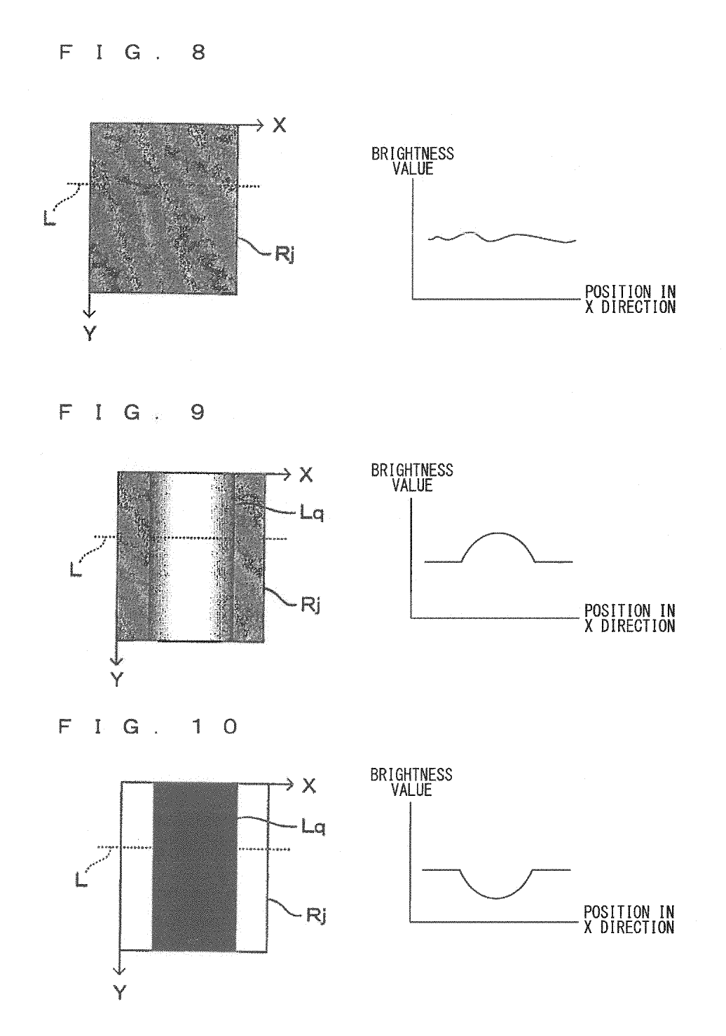

When the illumination direction is different from the imaging direction or the treatment liquid Lq has a dark color, the liquid column portion may have lower brightness than surroundings as shown in FIG. 10. Even in this case, a brightness distribution clearly different from that of the surroundings is seen in a portion corresponding to the liquid column. However, a typical treatment liquid used for substrate treatment is transparent or nearly white, and has higher brightness than the surroundings in many cases as shown in FIG. 9.

It can be seen that detecting the brightness characteristically appearing when the treatment liquid Lq appears in the determination region Rj as described above enables determining whether or not there is a treatment liquid. The determination of the present embodiment is performed to reliably determine whether or not there is a drop of the treatment liquid from an image for one frame without a comparison with other images, so that brightness change within the determination region Rj is detected by the following data processing.

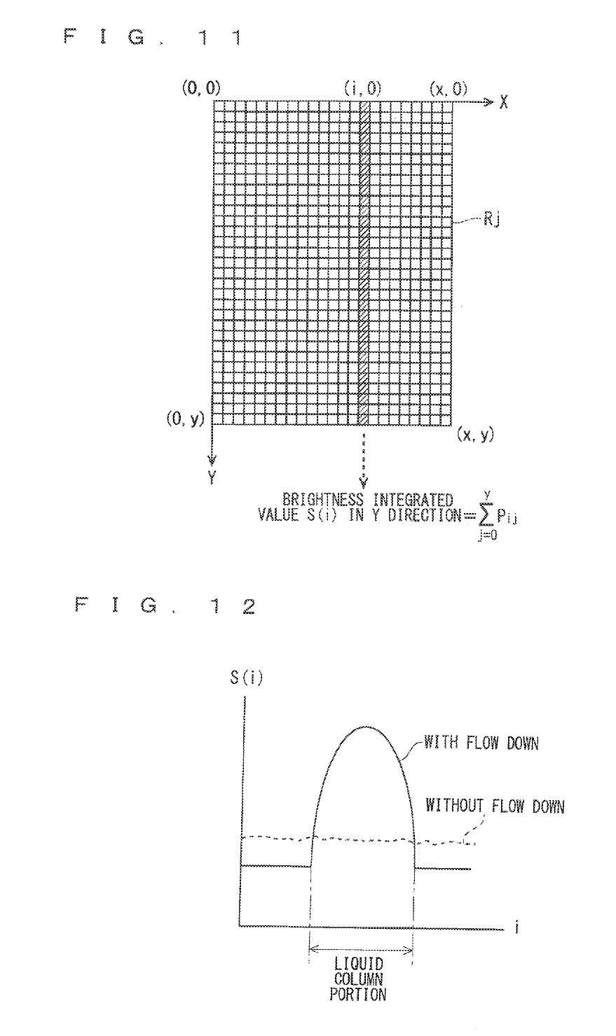

FIGS. 11 and 12 are each a diagram illustrating data processing in the determination process. As illustrated in FIG. 11, the upper left corner pixel in the determination region Rj is represented by coordinates (0, 0), and the lower right corner pixel is represented by coordinates (x, y). The determination region Rj is composed of (x+1) pixels in the X direction and (y+1) pixels in the Y direction, and the Y direction coincides with the vertical direction at the time of imaging. For a pixel column composed of a plurality of pixels each having a common X coordinate value and arrayed in a row along the Y direction among pixels constituting the determination region Rj, brightness values of respective pixels belonging to the pixel column are totaled. This is equivalent to integrating brightness values of all pixels (hatched pixels in FIG. 11) each with an X coordinate value of i (i is 0 or more and x or less), in the Y direction. Hereinafter, this total value is referred to as a “brightness integrated value”. When a brightness value of a pixel at the coordinates (i, j) is indicated as Pij, a brightness integrated value S(i) in the pixel row with the X coordinate value of i is expressed by Expression 1 below.

$$S ( i ) = {\sum }_{j = 0}^{y} {P}_{ij} \qquad [ Expression 1 ]$$

Here, the Y direction coincides with the vertical direction, or a direction in which the treatment liquid Lq discharged from the nozzle 43a drops toward the substrate W. Thus, when the treatment liquid Lq is continuously discharged from the nozzle 43a and drops in a columnar shape, the liquid column extending in the Y direction, or the direction of the pixel row, appears in the determination region Rj. When the pixel row is at a position corresponding to the inside of the liquid column, many pixels each have a brightness value peculiar to the treatment liquid Lq. Meanwhile, when the pixel column is at a position corresponding to a background portion around the liquid column, the pixel column has a brightness value of the substrate W in the background portion.

As a result, the brightness integrated value S(i) integrated in the Y direction for each pixel column includes the brightness value peculiar to the treatment liquid Lq, being more emphasized, when the pixel column is at the position corresponding to the inside of the liquid column. When the pixel row is at the position corresponding to the background portion, change in the density along the Y direction is canceled to cause the brightness integrated value S(i) to be a value close to an integrated value of an average brightness value of the substrate W.

As illustrated in FIG. 12, when a profile obtained by plotting the brightness integrated value S(i) for each value i, or for each X direction position of the pixel row, is used, a difference between the brightness profiles shown in the right diagram of FIG. 8 and the right diagram of FIG. 9 is more emphasized. That is, when there is a liquid column in the determination region Rj, the brightness value of the portion corresponding to the liquid column in the brightness profile shown in the right diagram of FIG. 9 is more emphasized to appear as a large peak (dip when the treatment liquid is dark) as schematically indicated by the solid line in FIG. 12, thereby allowing a difference from the background portion to be clear. Meanwhile, when there is no liquid column in the determination region Rj, no noticeable peak appears as indicated by the dotted line in FIG. 12.

Thus, when a change mode in the X-direction of the brightness integrated value S(i) in the Y direction is examined in one image, it can be determined whether or not there is a drop of the treatment liquid Lq in the determination region Rj without a comparison with other images. When the brightness integrated value S(i) in the pixel row along a drop direction of the treatment liquid Lq is used, even a small brightness change due to a drop of the liquid can be detected more accurately. This enables more reliable determination.

The determination region Rj needs to include a region where brightness changes depending on whether or not there is the treatment liquid Lq, but does not necessarily include the entire dropping path of the treatment liquid Lq. It is rather preferable that a liquid column of the treatment liquid Lq reach from an upper end to a lower end of the determination region Rj in the Y direction, as shown in FIG. 9. This means that the determination region Rj may include only a part of the dropping path. In addition, it is preferable that a background portion be included somewhat around the liquid column in the X direction. This enables a liquid column portion to be emphasized by contrast with the background portion.

Illumination from a direction substantially coinciding with the imaging direction causes a central portion of the liquid column in the X direction to have a particularly high brightness, and a peripheral portion thereof to have a lower brightness than the particularly high brightness. That is, a characteristic brightness profile appears in a central portion of a region corresponding to the liquid column in the determination region Rj in the X direction, so that using this characteristic brightness for detection does not necessarily require the background portion. The same is true even when there is a clear difference in brightness value between the liquid column portion and the background portion as described below.

The determination process specifically includes the steps of: introducing an appropriate evaluation value that quantitatively indicates a change mode in a profile of the brightness integrated value S(i) with respect to the X direction coordinate value i; and determining where or not there is a treatment liquid by comparing the evaluation value with a predetermined threshold value, for example. When a treatment liquid has higher brightness than a background in an image, the determination process can be performed as follows, for example.

FIGS. 13 to 15 are each a graph illustrating a relationship between an evaluation value and a threshold value. As shown in FIG. 13, when a range Rlq of brightness values possessed by the treatment liquid Lq and a range Rbg of brightness values of a background portion are known in advance and these brightness values are clearly separable, the brightness integrated value S(i) itself can be used as an evaluation value. That is, a brightness value slightly higher than the range Rbg of the brightness integrated value from the background may be set as a threshold value Sth. Basically, the threshold value Sth may be set to any value as long as it is between the range Rlq of brightness values of the treatment liquid Lq and the range Rbg of brightness values of the background portion. However, to detect a drop including a non-continuous liquid droplet, it is preferable to determine that there is a drop of the treatment liquid when the brightness integrated value S(i) exceeds the range Rbg of brightness values of the background. Thus, the threshold Sth is set to a value close to an upper limit of the range Rbg of brightness values of the background.

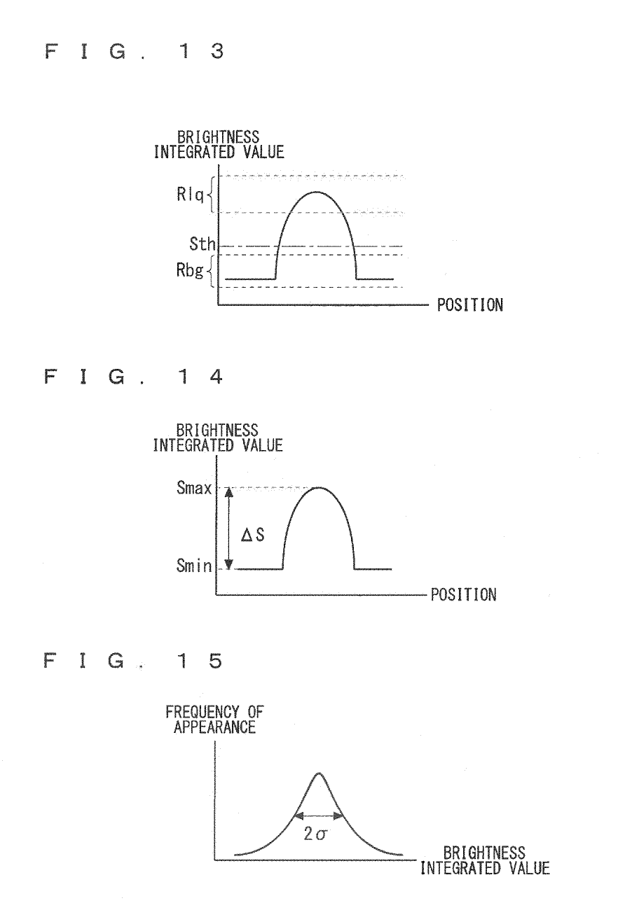

In addition, a difference ΔS between a maximum value Smax and a minimum value Smin in the profile of the brightness integrated value S(i) may be used as the evaluation value, as shown in FIG. 14. When there is a remarkable peak due to a drop of the treatment liquid, this difference ΔS has a large value. Meanwhile, when there is no drop of the treatment liquid, this difference ΔS has a very small value. Accordingly, the difference ΔS between the maximum value Smax and the minimum value Smin of the brightness integrated value S (i) may be set as the evaluation value, and a threshold value may be set for the evaluation value.

When a position occupied by the liquid column of the treatment liquid Lq and a position occupied by the background portion in the determination region Rj are previously known, it is also effective to compare the brightness integrated values S(i) between pixel rows at the respective positions. For example, when the determination region Rj is set such that the dropping path is positioned in its central portion in the X direction, a difference between a brightness integrated value in a pixel row positioned in the central portion of the determination region Rj in the X direction, and a brightness integrated value in a pixel row positioned in a peripheral portion thereof, can be used as the evaluation value. In addition, when a leftmost pixel row in the determination region Rj corresponds to the liquid column portion and a rightmost pixel row corresponds to the background portion, for example, a difference between the brightness integrated value S(0) of the leftmost pixel row, and the brightness integrated value S(x) of the rightmost pixel row, can be used as the evaluation value. In these cases, instead of a brightness integrated value of one pixel row, an average value of brightness integrated values of a plurality of pixels rows positioned close to each other, such as consecutive rows, may be used, for example.

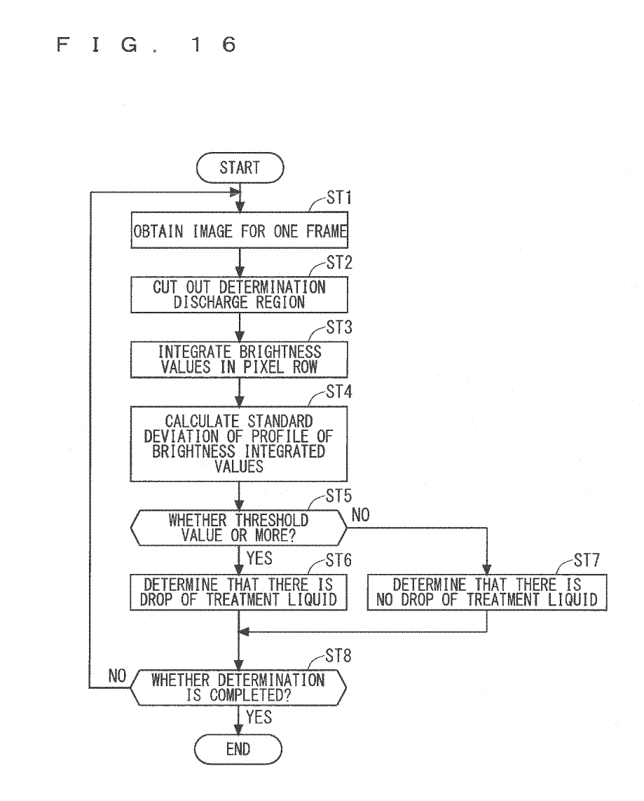

As shown in FIG. 15, a standard deviation σ when a plurality of brightness integrated values S(i) obtained for each pixel row is taken as a population may be used as the evaluation value. As shown in FIG. 12, a variation in the brightness integrated value S(i) is small when the determination region Rj includes no image of the treatment liquid, and the brightness integrated value S(i) greatly varies in accordance with the coordinate value i when the determination region Rj includes an image of the treatment liquid. Thus, the standard deviation σ among the brightness integrated values S(i) for each pixel row has a large value when an image of the treatment liquid is included, and has a small value when no image thereof is included. Accordingly, the value of the standard deviation σ can be an evaluation value quantitatively indicating a change mode of the brightness integrated value S(i). The standard deviation σ obtained with the brightness integrated values S(i) as a population is expressed by Expression 2 below. In Expression 2, m represents an average value of the integrated brightness values S(i).

$${σ}^{2} = \frac{1}{X + 1} {\sum }_{j = 0}^{x} {( S ( i ) - m )}^{2} \qquad [ Expression 2 ]$$

While the determination process described next is performed by using a value of the standard deviation as the evaluation value, the evaluation value is not limited to this, and a threshold value (determination threshold) suitable for an evaluation value to be used is appropriately set.

FIG. 16 is a flowchart of the determination process. First, the camera 72 takes an image for one frame (step ST1). The image processing unit 86 cuts out a partial region corresponding to the determination discharge region Rj from this image (step ST2). The calculation unit 811 integrates brightness values of respective pixels constituting the determination discharge region Rj for each pixel row (step ST3). The calculating unit 811 further calculates the standard deviation σ of the brightness integrated values as the evaluation value (step ST4).

The determination unit 812 compares the value of the standard deviation σ, which is the evaluation value, with a preset determination threshold value (step ST5). When the value of the standard deviation σ is equal to or larger than the determination threshold value, it is determined that there is a drop of the treatment liquid from the nozzle 43a (step ST6). When the evaluation value is less than the determination threshold value, it is determined that there is no drop of the treatment liquid from the nozzle 43a (step ST7) As a result, it is determined whether or not there is a drop of the treatment liquid in the image of the frame. The above processing is repeated until a timing at which the determination is to be ended (step ST8), and determination is made for respective images of each frame.

Next, the detection process in the present embodiment will be described. As described above, the detection process is a process of detecting whether or not there is dropping off in a non-supply period during which no liquid is actively supplied toward the nozzle. Hereinafter, the case where the nozzles 33a, 33b, 43a, and 43b (or the nozzle groups 33 and 43) are to be subjected to the detection process will be described. The detection process for each of the nozzle groups 33 and 43 is identical. Thus, the detection process for the nozzle group 43 will be described below in detail, and description of the nozzle group 33 is eliminated.

The detection process mainly includes the steps of: imaging while allowing an imaging visual field to include a dropping path through which a liquid drops from openings of the nozzle group 43 in the non-supply period during which supply of the liquid to the nozzle group 43 that is a target nozzle is stopped; and detecting whether or not there is a drop of the liquid using imaging results in the imaging step.

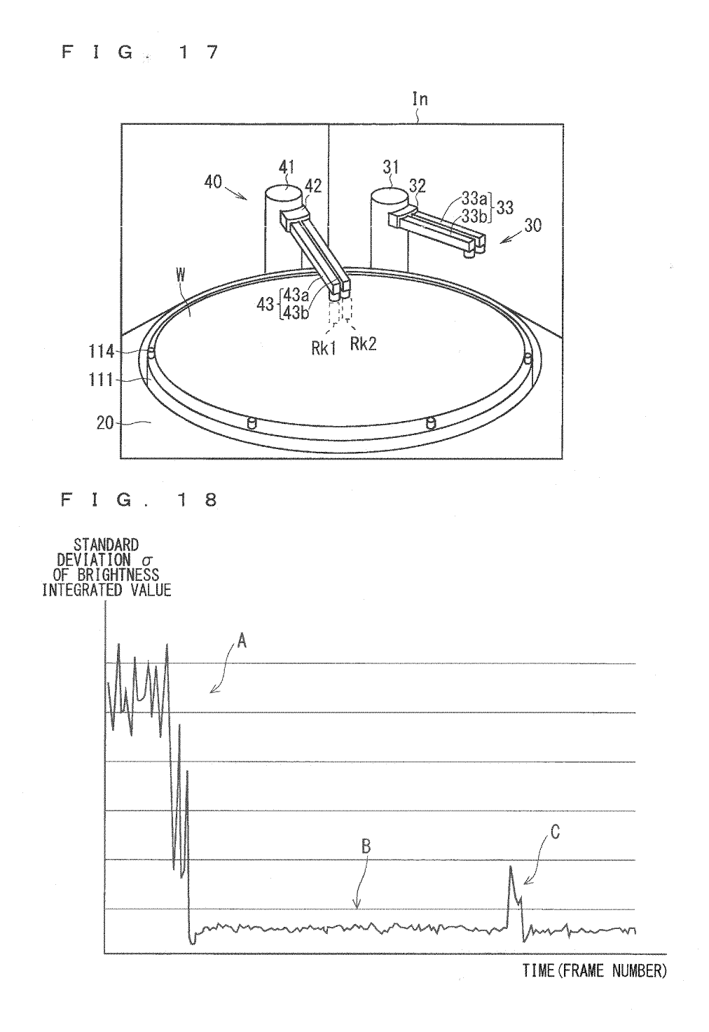

FIG. 17 illustrates an example of an image In obtained by imaging the nozzle group 43 positioned at the treatment position. The detection process is configured such that partial regions each including the dropping path in an image In are set as respective detection regions Rk1 and Rk2, as in the case of the determination process.

In the detection process, the determination unit 812 (detection unit) detects whether or not there is a drop of the liquid in the detection regions Rk1 and Rk2 in the image taken for one frame, as in the case of the determination process. Specifically, it is detected whether or not there is a drop of the liquid from each of the nozzles 43a and 43b on the basis of an evaluation value calculated from a brightness value of each of the pixels constituting the detection regions Rk1 and Rk2. A threshold value for this detection is preliminarily set by an operator. In contrast with the determination process in which a liquid column from the nozzle 43a in the supply period is to be imaged, the detection process in which dropping off of the liquid from the nozzles 43a and 43b in the non-supply period is to be imaged has a peak appearing in a profile of brightness integrated values, the peak being expected to be smaller in size than that in the case of the liquid column. Thus, it is desirable that a detection threshold value be set closer to an upper limit of the range Rbg of background brightness values than to the determination threshold value Sth (refer to FIG. 13).

In the present embodiment, the detection process has first to third detection processes that are different in processing timing.

The first detection process includes an imaging step that is performed during a period from the time when the nozzle group 43 is moved to the treatment position above the substrate W until a supply step is started (a period from time t3 to time t4). That is, in the imaging step of the first detection process, a target nozzle is set to the nozzle group 43 that has not yet supplied the treatment liquid until just before and that is immediately after movement.

Thus, when the treatment liquid is accumulated near openings of the nozzle group 43 in a flow path during the above period (e.g., when minute scratches are generated in an on-off valve provided in the flow path from a liquid supply source to the nozzle group 43, and the treatment liquid leaks downstream of the on-off valve), the treatment liquid inside the flow path and the accumulated liquid flow due to movement of the nozzle group 43, and thus dropping off of the treatment liquid can be detected in the first detection process. Meanwhile, when the treatment liquid is not accumulated near the openings of the nozzle group 43 in the flow path during the above-described period, dropping off of the treatment liquid is not detected in the first detection process.

In the first detection process, the supply step of supplying the treatment liquid from the nozzle 43a toward the substrate W is performed (period from time t4 to t5) immediately after the imaging step (period from time t3 to time t4). This enables the first detection process to eliminate a step of moving the nozzle group 43 to improve processing efficiency as compared with when the nozzle group 43 is moved only to detect dropping off of the treatment liquid as in the third detection process described below.

The second detection process includes an imaging step that is performed during a predetermined period immediately after supply of the treatment liquid to the nozzle group 43 is stopped (a period from time t5 to time t6). That is, in the imaging step of the second detection process, a target nozzle is set to the nozzle group 43 that has supplied the treatment liquid until just before.

Thus, when the treatment liquid is accumulated near openings of the nozzle group 43 in a flow path during the above period (e.g., when a suck back valve or the like provided in the flow path from the liquid supply source to the nozzle group 43 does not appropriately function, and the treatment liquid leaks downstream of the on-off valve), dropping off of the treatment liquid can be detected in the second detection process. Meanwhile, when the treatment liquid is not accumulated near the openings of the nozzle group 43 in the flow path during the above-described period, dropping off of the treatment liquid is not detected in the second detection process.

FIG. 18 is a graph illustrating a relationship between a value of a standard deviation σ as an evaluation value obtained for each frame, and time (frame number).

In the actual measurement example shown in FIG. 18, a portion corresponding to the period from time t4 to time t5 in FIG. 4 is indicated as a reference sign A. During the period indicated by the reference sign A, the determination process is performed for a liquid column extending from the opening of the nozzle 43a toward the substrate W, and a state with standard deviation σ of a high value continues.

In the actual measurement example shown in FIG. 18, a portion corresponding to the period from time t5 to time t6 in FIG. 4 is indicated as reference signs B and C. During the period indicated by the reference signs B and C, the second detection process is performed for the nozzles 43a and 43b in the non-supply period. During the period indicated by the reference sign B, a state with standard deviation σ of a low value continues and dropping off of the treatment liquid is not detected. Meanwhile, during the period indicated by the reference sign C, an increase in a value of the standard deviation σ is observed even for a short time, and dropping off of the treatment liquid is detected.

In the case of dropping off, its duration is irregular, so that a droplet may appear only in an image for one frame, for example. The detection process of the present embodiment is performed to detect whether or not there is a drop of the treatment liquid from individual frame images, so that dropping off of the treatment liquid can be reliably detected as long as a droplet can be taken in an image for at least one frame.

Next, the third detection process will be described. While the first and second detection processes are respectively performed consecutively with liquid treatment before and after the liquid treatment (time t4 to time t5), the third detection process is performed independently of the liquid treatment (time t4 to time t5).

Thus, when the third liquid treatment is performed, the nozzle group 43 is moved to the treatment position above the substrate W (time t10 to time t11), and then the nozzle group 43 is subjected to an imaging step for a predetermined period (time t11 to time t12).

Subsequently, immediately after the imaging step (a period from time t11 to time t12), a retraction step of retracting the nozzle group 43 from above the substrate W is performed (time t12 to time t13). As described above, the third detection process is performed to detect only dropping off of the treatment liquid by moving the nozzle group 43, and does not allow the liquid treatment or the like to be performed before and after the third detection process. As a result, the third detection process is less likely to be affected by another process than the detection process (the first detection process or the second detection process described above) that is performed together with the other process (e.g., liquid treatment) other than detection of dropping off of the treatment liquid, so that the detection of dropping off of the treatment liquid can be improved in accuracy.

In the third detection process to be performed to detect only dropping off of the treatment liquid, dropping off of the treatment liquid can be collectively detected for each of target nozzles by sequentially moving each of the target nozzles to the treatment position above the substrate W. The third detection process is performed each time liquid treatment is performed for a predetermined number of substrates W (e.g., substrates W of one lot), for example.

### 2. Modification

While the embodiments of the present invention are described above, various modifications of the present invention in addition to those described above may be made without departing from the scope and spirit of the present invention.

In the above embodiments, while there is described an aspect having target nozzles of the four nozzles 33a, 33b, 43a, and 43b among the five nozzles 33a, 33b, 43a, 43b, and 53 included in the substrate treatment apparatus 1A, the present invention is not limited to this. For example, all of the five nozzles 33a, 33b, 43a, 43b, and 53 provided in the substrate treatment apparatus 1A may be set as target nozzles, or only any one of the nozzles may be set as a target nozzle.

When one or more nozzles of the substrate treatment apparatus include a nozzle group composed of a plurality of nozzles moved integrally and a nozzle moved alone, it is preferable that a target nozzle include at least the nozzle group.

The reason is as follows. In general, in the case of a nozzle that is moved alone, even when dropping off of the treatment liquid occurs from the nozzle before and after the liquid treatment for the substrate W, only timing of dropping of the same treatment liquid is shifted, thereby reducing an adverse effect on the substrate W. In contrast, in the case of a nozzle group that is moved integrally, before and after one of the nozzle groups is used to apply the liquid treatment to the substrate W, the other of the nozzle groups may cause dropping off of the treatment liquid. In this case, a liquid different in kind drops onto the substrate W at an unintended timing, thereby increasing an adverse effect on the substrate W. Thus, when the target nozzle includes the nozzle group, dropping off of the treatment liquid can be detected for the nozzle that easily causes an adverse effect.

In the above embodiments, while there is described an aspect in which the camera 72 has an imaging visual field fixed in a region above the substrate W and it is detected whether or not there is a drop of the liquid from the target nozzle positioned above the substrate W in the imaging step, the present invention is not limited to this. For example, the imaging visual field of the camera may be set to include dropping paths of the corresponding target nozzles each positioned at a standby position. In general, the dropping path of each target nozzle positioned at the standby position is different (e.g., the drop paths of the respective nozzle groups 33 and 43 each positioned at the standby position are different). Thus, in an aspect according to the present modification, it is preferable that a plurality of the illumination units 71 and a plurality of the cameras 72 be disposed so that the dropping paths of corresponding target nozzles can be imaged.

In the above embodiments, while there is described an aspect of detecting whether or not there is a drop of liquid from the target nozzle by comparing a brightness evaluation value of an image taken for one frame with the threshold value, the present invention is not limited to this. In addition to this, publicly known various detection aspects may be used. The aspect of detecting whether or not there is a drop of the liquid includes an aspect of detecting only a drop of the liquid, an aspect of detecting only no drop of the liquid, and an aspect of detecting both a drop of the liquid and no drop of the liquid.

In the above embodiments, while there is described an aspect in which an object to be supplied with liquid from the nozzle is the substrate W and the substrate treatment apparatus serves as a detecting device for detecting dropping off of the treatment liquid, the present invention is not limited to this. For example, a structure or the like other than the substrate W may be used as an object.

According to an object of treatment, different treatment liquids may be discharged from the corresponding nozzles 33a, 33b, 43a, 43b, and 53, or the same treatment liquid may be discharged therefrom. One of the nozzles may discharge two or more kinds of treatment liquid. In addition, the configuration and the number of the nozzles can be appropriately changed.

While the detecting method and the detecting device according to the embodiments and their modifications are described above, these are examples of preferred embodiments of the present invention and do not limit the scope of the present invention. Within the scope of the invention, the present invention allows the respective embodiments to be freely combined with each other, any component of each of the embodiments to be modified, or any component of each of the embodiments to be eliminated.

### EXPLANATION OF REFERENCE SIGNS

1A to 1D: substrate treatment apparatus
11: spin chuck
33a, 33b, 43a, 43b, 53: nozzle
71: illumination unit
72: camera (imaging unit)
80: control unit
81: CPU
811: calculation unit
812: determination unit (detecting device)
W: substrate

1. A detecting method comprising the steps of:
imaging in a non-supply period during which supply of liquid to a target nozzle among one or more nozzles is stopped while allowing an imaging visual field to include a dropping path through which the liquid drops from an opening of the target nozzle; and
detecting whether or not there is a drop of said liquid using an imaging result in said imaging step.

2. The detecting method according to claim 1, wherein
said imaging visual field is a region above an object to which said liquid is supplied, and
in said imaging step, it is detected whether or not there is a drop of the liquid from said target nozzle positioned above said object.

3. The detecting method according to claim 2, further comprising the step of:
retracting said target nozzle from above said object immediately after said imaging step.

4. The detecting method according to claim 2, further comprising the step of:
supplying said liquid toward said object from said target nozzle immediately after said imaging step.

5. The detecting method according to claim 1 4, wherein
said one or more nozzles include a nozzle group consisting of a plurality of nozzles that is integrally moved, and a nozzle that is moved alone, and
said target nozzle includes at least said nozzle group.

6. A detecting device comprising:
one or more nozzles;
an imaging unit that, in a non-supply period during which the supply of liquid toward a target nozzle among said one or more nozzles is stopped, images a dropping path through which the liquid drops from an opening of the target nozzle; and
a detection unit that detects whether or not there is a drop of said liquid using an imaging result of said imaging unit.
